(19) United States
(12) Patent Application Publication
(10) Pub. No.: US 2006/0085532 A1
(43) Pub. Date: Apr. 20, 2006

(54) Remote management of communication devices

(76) Inventors: Wenjing Chu, Sunnyvale, CA (US); Bisong Tao, San Jose, CA (US); Allan Rubens, Ann Arbor, MI (US); Andrew Adams, Ann Arbor, MI (US); James (Qiuming) Li, Sunnyvale, CA (US); Susan Hares, Saline, MI (US)

Correspondence Address: PERKINS COIE LLP, P.O. BOX 2168, MENLO PARK, CA, 94026, US

(21) Appl. No.: 11/121,163

(22) Filed: May 2, 2005

Related U.S. Application Data
(60) Provisional application No. 60/567,192, filed on Apr. 30, 2004.

(51) Int. Cl. G06F 15/173

(52) U.S. Cl. 709/223

(57) ABSTRACT

A canonical interface for remote interaction with communication devices in a network is described. The canonical interface supports interactions for communicating with remote devices for the configuration of router/communication software or devices; querying run-time information (dynamic and static) and statistics from router/communication software or devices; performing multi-system consistency checking; reporting management events from router/communication software or devices; revision control; and prioritizing urgent network requests over standard network management throughput.

### CROSS REFERENCE TO RELATED APPLICATIONS

This application claims the benefit of U.S. Provisional Patent Application No. 60/567,192 filed Apr. 30, 2004, entitled, “REMOTE Management OF COMMUNICATION DEVICES,” by Hares et al., and which is hereby incorporated by reference in its entirety.

This application hereby incorporates by reference in their entirety each of the following U.S. Patent Applications: U.S. patent application Ser. No. 10/648,141, filed on Aug. 25, 2003 (Atty. Docket No.: 41434-8001.US00); U.S. patent application Ser. No. 10/648,146, filed on Aug. 25, 2003 (Atty. Docket No.: 41434-8002.US00); U.S. patent application Ser. No. 10/648,758; filed on Aug. 25, 2003 (Atty. Docket No.: 41434-8003.US00); and U.S. Patent Application No.: ______ filed May 2, 2005, entitled, VIRTUALIZATION OF CONTROL SOFTWARE FOR COMMUNICATION DEVICES by Susan Hares et al. (Atty. Docket No.: 41434-8009.US01).

### TECHNICAL FIELD

The present invention is directed to networks, and more specifically to the remote management of network communication devices.

### BACKGROUND

Router or other communications devices may be managed locally by use of a local interface coupled to a particular device or remotely via a network. A local interface can be a file located on a disk associated with a device or a local terminal that can input management commands to a device or output results from the management commands. A file interface can contain configuration commands that allow the communication device to select different protocols for the communication device. The communication device can also record events or debugging information to a file. Another variant of the file interface is the remote loading of a configuration image via a network protocol. The file transfer can be done using generic network protocols (NFS, File Transfer Protocol (FTP)) or a protocol that is specific to a network boot image (Trival File Transfer Protocol (TFTP), for example). Examples of remote management protocols in the prior art include:
OSI Common Management Interface Protocol (CMIP),
Simple Network Management Protocol (SNMP),
IETF Agent X protocol (RFC 2741), and the
IETF COPS protocol (RFC 2748).

These remote management protocols work on a databases of managed objects. CMIP operates on GDMO databases defined by ISO's management structure (ISO 10165). SNMP and Agent X operate on the IETF SMIv2 structure of Management Information Bases (MIBs) defined by RFC 2578, 2579, 2580. The COPS protocol also exchanges information about a policy information base (PIB) made up of a collection of Provisioning Classes (PRCs) and Provisioning Instances (PRI) residing in virtual store.

Another type of local interface is a user interface in which specific ASCII commands are input using what is often denoted as a “Command Line Interface (CLI). The user, via the CLI, can input configuration commands, query for information, or request logging of events or debugging information. The information that is queried can be static, based on configurations or a running instance, or dynamic such as statistics about a network device. Remote login to the local process can be made via a network connection (telnet, ssh) to a CLI. However, all processing is performed on the local device.

Parsing management commands (including file, binary, or command line) may consume a considerable amount of time. In some communication devices, a communication process offloads the parsing of commands that manage the device to a remote process or device. The validation of the information is often done in two stages: syntactic validation and run-time instance validation. This process allows remote devices to off-load syntactic validation to a remote process.

One of the major causes of network outage (Yankee Group 2002, Infonetics 2003) is erroneous configuration of network devices. Configurations can be installed via remote management interfaces or local interfaces. If remote interfaces are used, many management stations may alter configurations on a single device. A carefully tuned management back-end system may load configuration parameters into a device. A human network operator may use a remote (or local) user interface to alter a few parameters to an erroneous configuration. The human operator may be operating on a previous revision of the information. In an environment with hundreds or thousands of complex devices, it is critical to quickly configure devices and quickly determine if a configuration has been changed.

Problems with current network management protocols include:

Urgent network requests (configuration, network management) often fall behind large a data transfer requested by network management;
Current network protocols lack control over revisions and lack mechanisms for rapidly determining if configurations have been altered;
There is a lack of an efficient hierarchical data structure that supports configuration information and that has a hierarchy level with more than 3 levels; and
There is no ability to separate the message data formats for deployment in different environments such as within a process, between processes on a device, between nodes, or between multiple nodes.

The management of devices may include the configuration of nodes, query of management information, or notification of an event, actions or packets. Querying of run-time information can either return configuration information, statistics, and the retrieval of potentially large amounts of real-time data (such as routing table retrievals). The mixing of large amounts of real-time data with urgent configuration requests can result in configuration requests inadvertently becoming low priority traffic. Thus, there is a need to place high priority traffic requests (such as requests related to configuration, events, short dynamic queries, synchronization) to be put on a different management link than the standard SNMP or Agent X throughput.

Another problem with the prior art is that support for revision control is minimal in most remote network protocols. The SNMP DPI has commit/roll-back features on a local system, but does not allow such changes to be communicated to a remote station. There is a need for a remote network management which supports commit and rollback features in addition to the following:
A tracking source for tracking changes within station network management; and
An indication of change in the leaf nodes of a management hierarchy associated with a particular piece of information.

In view of the foregoing, there is a need for a system and method for supporting urgent network management requests, revision control, and mechanisms for separating message data formats for deployment in different environments.

### SUMMARY

The invention includes a canonical interface facilitating remote management of communication devices in a network. The communication devices may be managed from a variety of user interfaces or expert systems. Communication equipment which may be managed includes but is not limited to routers, switches, mobile devices, servers. According to certain embodiments, the canonical interface allows for an incremental method operating on a hierarchical representation of data. Such a hierarchical representation of data logically divides objects into tree structures and instances of the tree structures. According to certain embodiments, the canonical interface may include a user-interface, a remote message interface, and a router/communications process interface.

According to one aspect of certain embodiments, the remote message interface is used for encoding information into messages and passing the messages between a remote management process and the router/communication process associated with the network. The remote message interface can separate message data formats for deployment in different environments such as within a process, between processes on a device, between nodes, or between multiple nodes. Any communication protocol that is suitable for exchanging messages can be used.

According to certain embodiments, the canonical interface supports interactions for communicating with remote devices for configuring router/communication software or devices; querying run-time information (dynamic and static) and statistics from router/communication software or devices; performing multi-system consistency checking; reporting management events from router/communication software or devices; revision control; and Giving urgent network requests top priority over standard SNMP throughput. These and other embodiments of the invention are described in further detail herein.

### BRIEF DESCRIPTION OF THE DRAWINGS

FIG. 1 shows the components of a canonical method for remote interaction between two user interfaces, according to certain embodiments.

FIG. 2 illustrates an example of an instance of an MIO tree structure, according to certain embodiments.

FIG. 3 illustrates an example of level 1 top nodes for an MIO tree for a router with layer 3 routing and MPLS switching, according to certain embodiments.

FIG. 4 illustrates that the AMI interface can provide both local and remote interaction to a variety of user interfaces or expert systems, according to certain embodiments.

FIG. 5 shows some of the AMI interface functions for creating and navigating the hierarchical tree structure of network management objects, according to certain embodiments.

FIG. 6 shows the nodes and tables impacted by a full tree commit operation, according to certain embodiments.

FIG. 7 illustrates the operation of the mio_clear_pending on a MIO tree, according to certain embodiments.

FIG. 8 illustrates the operation of the mio_set, mio_delete, mio_sync commands on a MIO tree, according to certain embodiments.

FIG. 9 illustrates the mio_sync_next operation on the MIO tree, according to certain embodiments.

FIG. 10 illustrates a sample message header, according to certain embodiments.

FIG. 11 shows the “set”, “get”, and “dget” message exchanges, according to certain embodiments.

FIG. 12 shows the Sync Message, Sync_Next message and Event Message sequences, according to certain embodiments.

FIG. 13 shows the synchronization and locking processes, according to certain embodiments.

FIG. 14 is a block diagram that illustrates the components of a node locking mechanism, according to certain embodiments.

### DETAILED DESCRIPTION

Remote management of a device occurs when the management functions run on a different device or different process across the network. The remote management may perform all of the management functionality (configuration, query, events or logging) on the remote device or just part of the functionality on the remote device.

The remote management system may utilize query, sets, and event requests via network protocols to obtain information from the node. Remote management systems process the information received from remote nodes utilizing input from a user interface, constraint based templates, or expert systems. The network protocol may contain information encoded in bytes defined by a network protocol or via a markup language such as extensible Markup Language (XML).

According to certain embodiments of the invention, a canonical interface is used for remote interaction with communication devices in a network. The communication devices may be from a variety of user interfaces or expert systems. Communication equipment includes but is not limited to routers, switches, mobile devices, servers. According to certain embodiments, the canonical interface allows for an incremental method operating on a hierarchical representation of data. Such a hierarchical representation of data logically divides objects into tree structures and instances of the tree structures.

According to certain embodiments, the canonical interface includes: 1) a user-interface, 2) a remote message interface, and 3) a router/communications process interface.

According to one aspect of certain embodiments, the remote message interface is used for encoding information into messages and passing the messages between a remote management process and the router/communication process associated with the network. The remote message interface can separate message data formats for deployment in different environments such as within a process, between processes on a device, between nodes, or between multiple nodes. Any communication protocol that is suitable for exchanging messages can be used.

According to certain embodiments, the canonical interface supports interactions for communicating with remote devices for: 1) Configuration of router/communication software or devices; 2) Querying run-time information (dynamic and static) and statistics from router/communication software or devices; 3) Performance of multi-system consistency checking; 4) Reporting of management events from router/communication software or devices; 5) Revision control; and 6) Giving urgent network requests top priority over standard SNMP throughput.

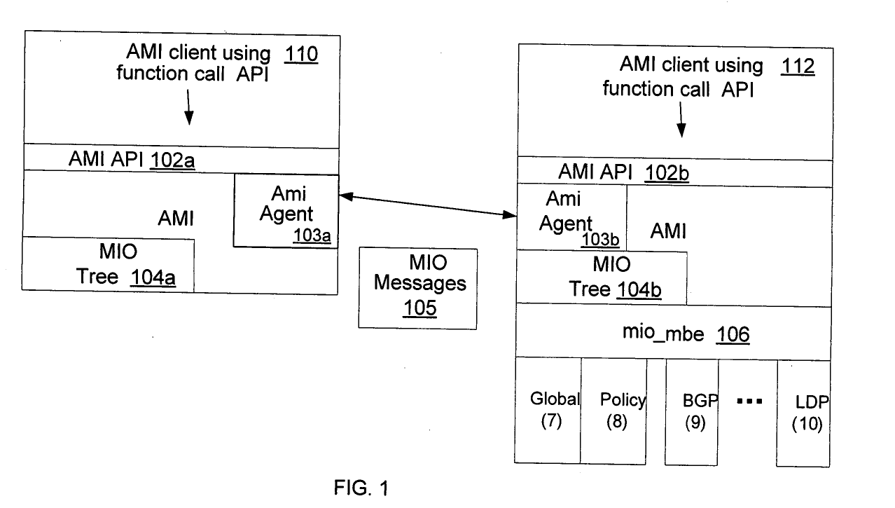

FIG. 1 shows the components of a canonical interface for remote interaction between two user interfaces, according to certain embodiments. FIG. 1 depicts user interface processes 110 112, application programming interfaces 102a _and 102b, “AMI” agents 103a, 103b, management information object trees 104a, 104b, a remote message interface 105, and corresponding router/communication interfaces 106a, 106b. The user interface is also referred to herein as an Advanced Management Interface (AMI) and comprises a canonical interface, as further described herein.

The AMI canonical interface points to a node in a hierarchical tree management database structure (such as trees 104a or 104b) for a communication instance and remotely performs operations on that node for that instance. The nodes are called “Management Information Object” (MIO) nodes. Such a hierarchical tree structure is called an “MIO tree”. The canonical interface supports operations that include: set, modify, delete, or query information. The information queried in an MIO tree can be dynamic or static, according to certain embodiments. The AMI interface supports the ability to lock certain portions of the hierarchical tree structure to restrict the ability to set, modify, delete, or query information. The portions of the tree that can be locked are a node, any information associated with the node, and a node's children (or recursively the children's children).

The AMI canonical interface can also set-up remote event reporting or actions at any node in the hierarchical tree, according to certain embodiments. In addition, the AMI canonical interface can perform synchronization checks on any portion of the tree by comparing the generated synchronization values with the set synchronization values.

If multiple user interfaces access the information within a single routing process, the AMI canonical interface supports tracking of the originating user interface locking of a node during a particular operation (set, modify, query, dynamic query, deletion or addition of nodes). The AMI canonical interface provides a synchronization identifier that provides revision control on the node structure or the data associated with a node structure.

The AMI canonical interface also provides the ability to commit a set of nodes within the tree to a particular process. Non-limiting examples of these processes are: configuration processing to align protocols (commit), synchronization checking (sync), and event tracking.

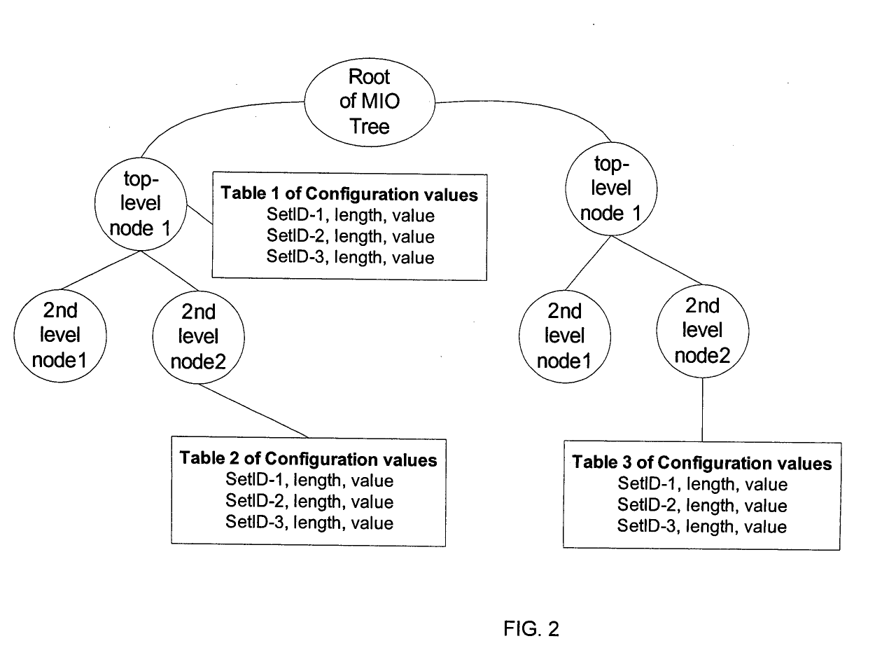

The hierarchical representation of data logically divides objects into tree structures and instances of the tree structures. FIG. 2 illustrates an example of an MIO tree structure corresponding to an instance, according to certain embodiments. FIG. 2 shows an MIO tree 200 with a root 202, top-level nodes 204, 206, second level nodes 208, 210, 212, 214, and tables 216, 218 and 220.

The MIO tree structure is described as a series of nodes. Each node is described by the series of nodes that lead from the root to the particular node in the tree structure. The AMI canonical interface can be used to point to a node in the hierarchical tree structure, identify an instance and perform operations on that node for that instance. The AMI canonical interface supports methods that: set, modify, delete, and query information (dynamic and static). The AMI canonical interface supports the ability to lock certain portions of the hierarchical tree structure from sets, modify, deletion, or query. A node can have many data elements associated with it. The node elements are identified by a SETID. According to certain embodiments, the value for an element can be identified by a SETID value, a parameter length and a value.

Each node in the MIO tree is in a set of parent-child relationships. In embodiments of the invention, each node can have exactly one parent but many children. The AMI canonical interface supports several operations related to a “node” of the tree, such as:
Set information within node
Get information from a node
Delete information associated with the node,
Get dynamic information from the node,
Create a new node,
Destroy a node,
Modify data contained in a node, and
Retrieve data contained in a node.

In embodiments of the invention, the node operations utilize node instance identifiers that include arrays of node ids. In FIG. 2, Table 2 of configuration values (table 218) is associated with top-level node 1 204, 2nd-level-node 2 208. Table 3 of configuration values (table 220) is associated with top-level node 2, and 2nd level node 2.

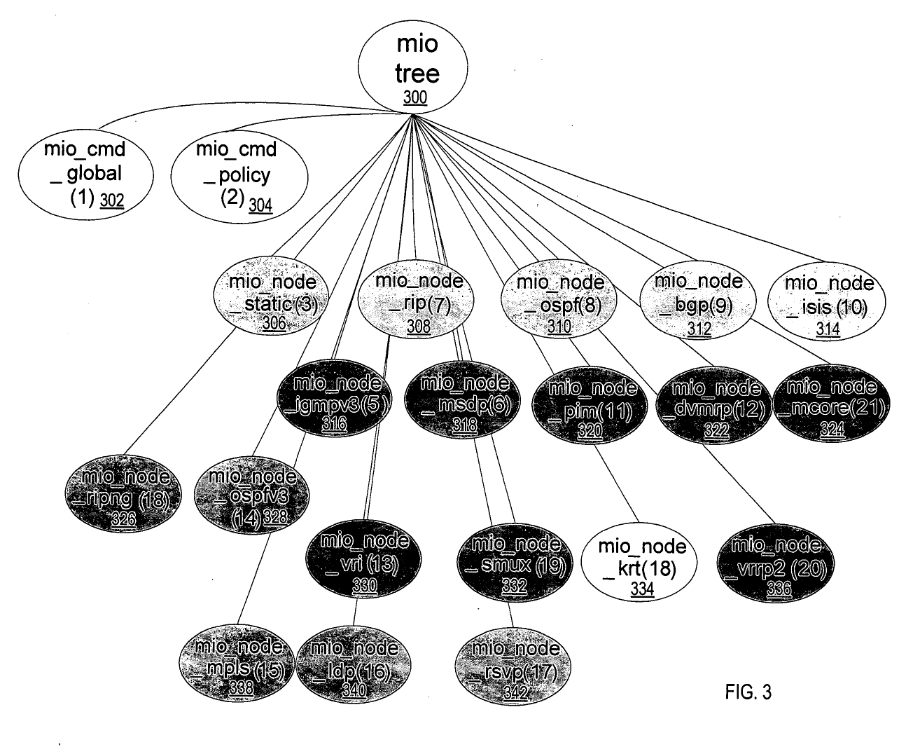

FIG. 3 illustrates an example of level-1 top nodes for an MIO tree for a router with layer 3 routing and MPLS switching, according to certain embodiments. In FIG. 3, MIO tree 300 comprises level-1 nodes 302-342. Examples of the information queried includes (but is not limited to) current configuration values, default configuration values, run time information, statistics, dynamic events, and management events.

The canonical interface is adapted to navigate the hierarchical data tree by:
Walking the tree starting at a particular point;
Initializing the hierarchical tree structure,
Initializing the full canonical node structure
Initializing the canonical interface point to a particular node in the MIO tree for subsequent queries or interaction,
Querying an instance of the MIO tree in AMI for: configurations, events, actions, synchronization and queries to the MIO tree, and
Initiating, continuing or halting a walk of the hierarchical node structure starting at a particular node.

The range of walking a tree can be limited to within a certain portion of the hierarchy, according to certain embodiments. The locking mechanisms can also be applied to the navigation of the tree structure.

Further, the canonical interface provides the ability to commit a set of nodes to processing for:
Configuration processing;
Synchronization;
Actions;
Dynamic Queries for gathering of management information (such as protocol statistics); and
Event reporting.

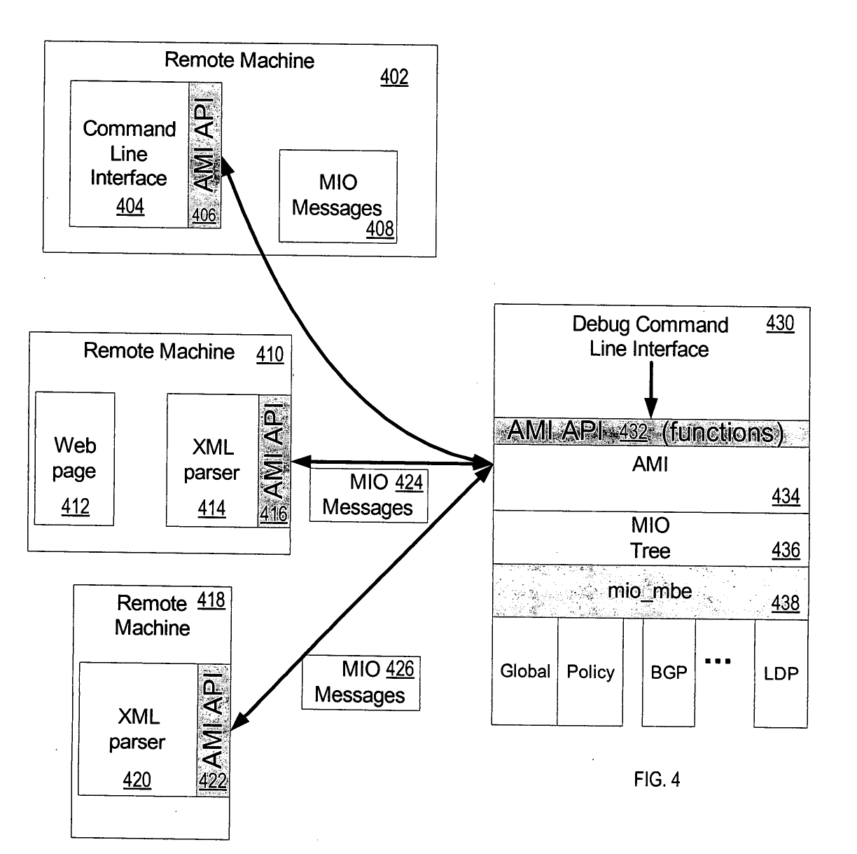

The AMI canonical interface places no restrictions on the location of the user-interface. FIG. 4 illustrates that the AMI interface can provide both local and remote interaction to a variety of user interfaces or expert systems, according to certain embodiments. FIG. 4 shows remote machines 402, 410, 418, and a debug command line interface 430. Remote machine 402 includes MIO messages 408, a command line interface 404 and an AMI API 406. MIO messages 408 are passed between remote machine 410 and debug command interface 430. Remote machine 410 includes a web page 412, an XML parser 414 and an AMI API 416. MIO messages 424 are passed between remote machine 410 and debug command interface 430. Remote machine 418 includes an XML parser 420 and an AMI API 422. MIO messages 426 are passed between remote machine 418 and debug command interface 430. Debug command interface 430 includes AMI 434, an AMI API 432, a MIO tree 436, and a Mio_mbe 438.

The location of the remote access can be a different process within the same hardware devices, on a different hardware device sharing the same physical back plane or on a totally remote device. Any number of user interfaces can be supported by the AMI interface. Non-limiting examples of user interfaces include command line interfaces, XML interfaces, and web interfaces. The remote process can communicate with the routing process via any communication method that can exchange messages.

Storing Router/Communication Device Information In A Tree Structure

The AMI canonical interface can be used to point to a node in the hierarchical tree structure, identify an instance and perform operations on that node for that instance. In accordance with embodiments of the invention, the data structures that store the hierarchical tree structure may be as follows:

mio_tag_t - a tag that identifies a node. TABLE 1 herein describes mio_tag_t
structure
mio_tag_array_t - an array of tags that describe the path to a particular node on the
hierarchical tree. TABLE 2 herein describes mio_tag_array_t structure
mio_tag_value_array_t - an array of mio_tag_t values where element tag identifies
the SETID of the element, the length of the value, and the value. TABLE 3 herein
describes mio_tag_value_array_t structure
mio_error_t - a pointer to a list of generated errors. TABLE 4 herein describes
mio_tag_t structure
mio_dget_reply_fn_t - TABLE 5 herein describes mio_dget_reply_fn_t structure
mio_dget_t - an array of parameters for dynamic query, routines to process
information in responses to dynamic query. TABLE 6 herein describes mio_dget_t -
tag structure
mio_dget_queue_t - a pointer to a queue of dynamic queries in process with each
entry being a mio_dget_t structure. TABLE 7 herein describes mio_dget_queue_t
structure

The type configuration information associated with a node is stored in _mioConfType_t.

TABLE 1
mio_tag_t

| | | |
|---|---|---|
| mt_index | Global Index of this node | Integer |
| mt_keylen | Length of key | Integer |
| mt_key | Key | Pointer |

TABLE 2
mio_tag_array_t

| | | |
|---|---|---|
| mta_tags[MIO_MAX_DEPTH] | Array of mioTag_t | Integer |
| | structures used to specify | |
| | path to a node | |
| mta_count | Number of tags in | Integer |
| | mta_tags | |

TABLE 3
mio_value_tag_array_t

| | | |
|---|---|---|
| mta_tags[MIO_MAX_VALUE_DEPTH] | Array of values | Integer |
| mta_count | Number of tags in | Integer |
| | mta_tags | |

TABLE 4
mio_error_t

| | | |
|---|---|---|
| me_error_list (v2 only) | Pointer to list of errors | pointer |
| me_error_count (v2 only) | Number of errors on list | Integer |
| me_commit_node (v2 only) | Node being committed | pointer |
| | (mio_tag_t *) | |
| me_error_code (v1 only) | Error code | Integer |
| me_array_index (v1 only) | Offending array index | Integer |
| me_cfg_error_code (v1 | Node being committed | Integer |
| only) | | |
| me_node (v1 only) | node storage for | Pointer |
| | mio_cfg_errf | |
| Me_error_msg (v1 only) | Error message | Character |
| | | array |

TABLE 5
typedef int (*mio_dget_reply_fn_t) (task *tp,u_int16 handle,
mio_path_array_t *ipath, mio_value_array_t *data, int b, int f)

| | | |
|---|---|---|
| task * tp | Task pointer | Task |
| Handle | | Unsigned |
| | | integer |
| mio_value_tag_array_t *ipath | Path to reply node | |
| mio_value_tag_array_t *data | Values set in arrays | |

TABLE 6
mio_dget_queue_t

| | | |
|---|---|---|
| mio_dget_t * | Pointer to head of link list with | Pointer |
| | mio_dget entries that contain | |
| | entries to call back. | |

TABLE 7
mio_dget_t

| | | |
|---|---|---|
| mio_dget_t * dq_link | Pointer to next entry in link list of | Pointer |
| | dget request | |
| mio_dget_node_t * dnode | dnode array that gives parameter | Pointer |
| | lists for dynamic query | |
| void * params | Query parameters | Pointer |
| Task *tp | Task initiating this query | Pointer |
| Task_job *job | Query job | Pointer |
| Void *job_data | Query Job's data | Pointer |
| mio_dget_jobfn_t job_fn | Job callback function | Pointer |
| mio_dget_jobfree_t | Callback to free job data | Pointer |
| job_free | | |
| mio_dget_reply_fn_t | Callback function to receive data | Pointer |
| reply | | |
| mio_dget_type_t type | Type of dynamic query | Integer |
| Mio_ipath_t | Path to mio node | Pointer |
| Mio_tag_value_array_t * | Values returned | Pointer |
| _u_int16 handle | Cookie for this dynamic response | integer |
| _u_int8 version | Version of the dynamic api | integer |
| flag_t flags | Processing flags | Integer |

Referring back to FIG. 2, a node may have several parameters in a table associated with a configuration node. For example, in table 216 of FIG. 2, each parameter in a node's table is identified by a SETID value. Parameters come in 3 classes: 1) key, 2) required, and 3) optional. Key values are present when a node is committed and cannot be modified. According to certain embodiments, so called “required” values are present at commit time and can be modified but not reset. Optional values are not required when a node is committed and can be modified or reset. Resetting a value restores the value to the default settings, according to certain embodiments.

The value for a parameter has a predefined type specification. The predefined type allows the user-interface to associated a known set of lengths and meanings with the value provided.

Canonical Methods To Navigate Hierarchical Nodes Via User Interface API

The AMI canonical interface provides the following functions within the user interface API to aid in creating and navigating the tree of hierarchical nodes.

MIO_CREATE_TAG_ARRAY - creates a tag array structure for a path
to a node
MIO_DESTROY_TAG_ARRAY - destroys the tag array structure for
a path to a node
MIO_PUSH_TAG - adds node tag to the array of tags that describe a
node
MIO_POP_TAG - removes the top tag from the array of tags that
describe a node

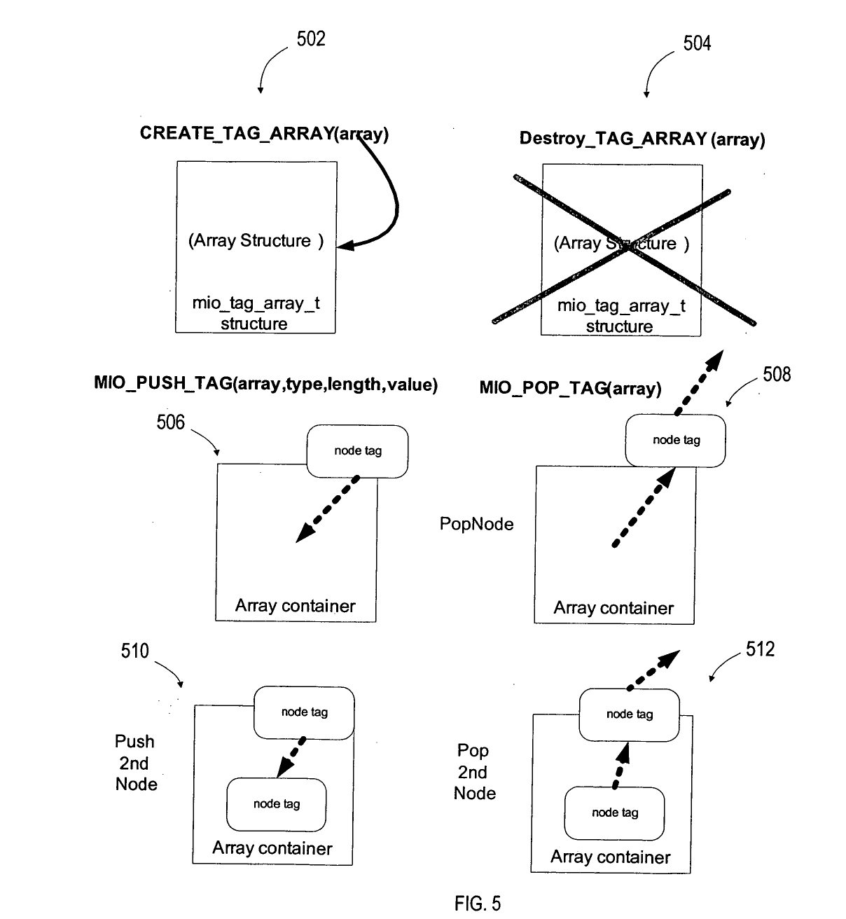

FIG. 5 shows the AMI interface functions described above for creating and navigating the hierarchical tree structure of network management objects, according to certain embodiments. FIG. 5 shows a CREATE_TAG_ARRAY 502, a DESTROY_TAG_ARRAY 504, an MIO_PUSH_TAG 506 with Push_{—}2^{nd}_node 510, and an MIO_POP_TAG 508 with Pop_{—}2^{nd}_node 512.

Such navigation functions allow the AMI canonical interface to provide an efficient set-up for the hierarchical tree structure of network management objects.

The MIO API uses the mio_tag_array_t structure to point to the node in the MIO Tree. Every command operates on a node or several nodes in the MIO tree structure of network management objects.

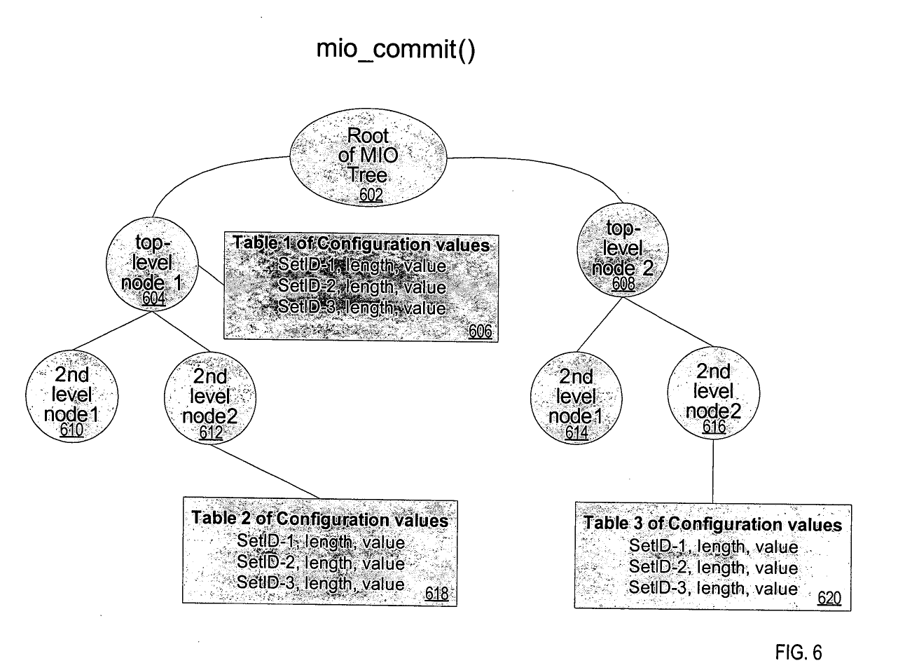

Some API calls operate on all nodes in the tree. An example of a mio_command operating on the full tree is the mio_commit. FIG. 6 shows the nodes and tables impacted by a full tree commit operation, according to certain embodiments. FIG. 6 shows a root 602 of the MIO tree, top level nodes 604, 608, and second level nodes 610, 612, 614, 616. Table 606 of configuration values is associated with top level node 604, table 618 of configuration values is associated with second level node 612, and table 620 of configuration values is associated with second level node 616.

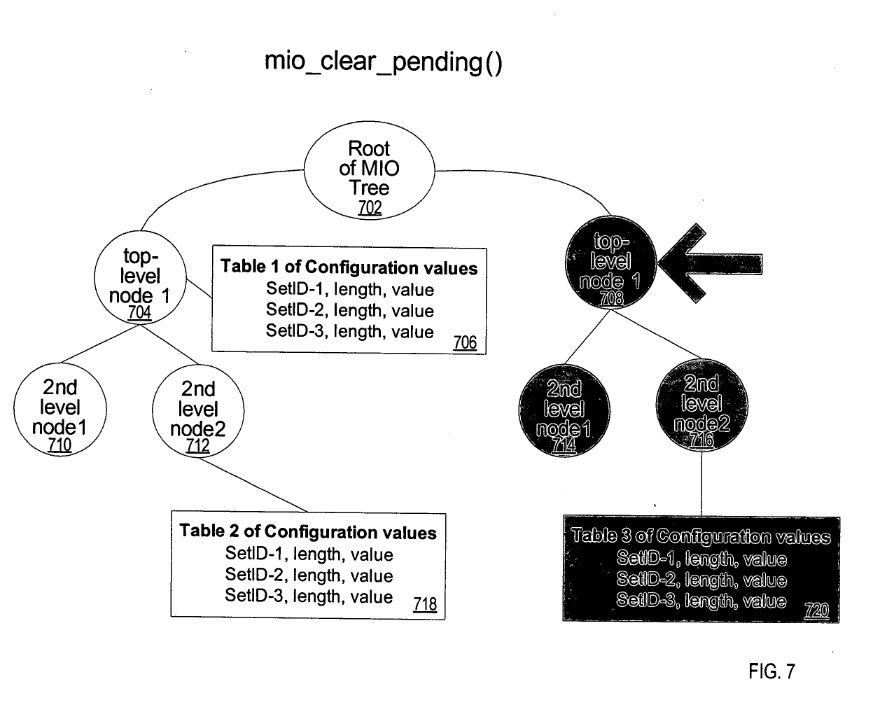

Some AMI API calls (commands) operate from a point in the MIO tree (taken as the root) and operate toward all descendants of that root. Examples of such a mio command is the mio_clear_pending and the mio_delete command. The command walks through these descendants performing the commands. FIG. 7 illustrates the operation of the mio_clear_pending on a MIO tree, according to certain embodiments. FIG. 7 shows a root 702 of the MIO tree, top level nodes 704, 708, and second level nodes 710, 712, 714, 716. Table 706 of configuration values is associated with top level node 704, table 718 of configuration values is associated with second level node 712, and table 720 of configuration values is associated with second level node 716. In FIG. 7, the mio_clear_pending operation is on top level node 708 and the descendants of top level node 708, as an example.

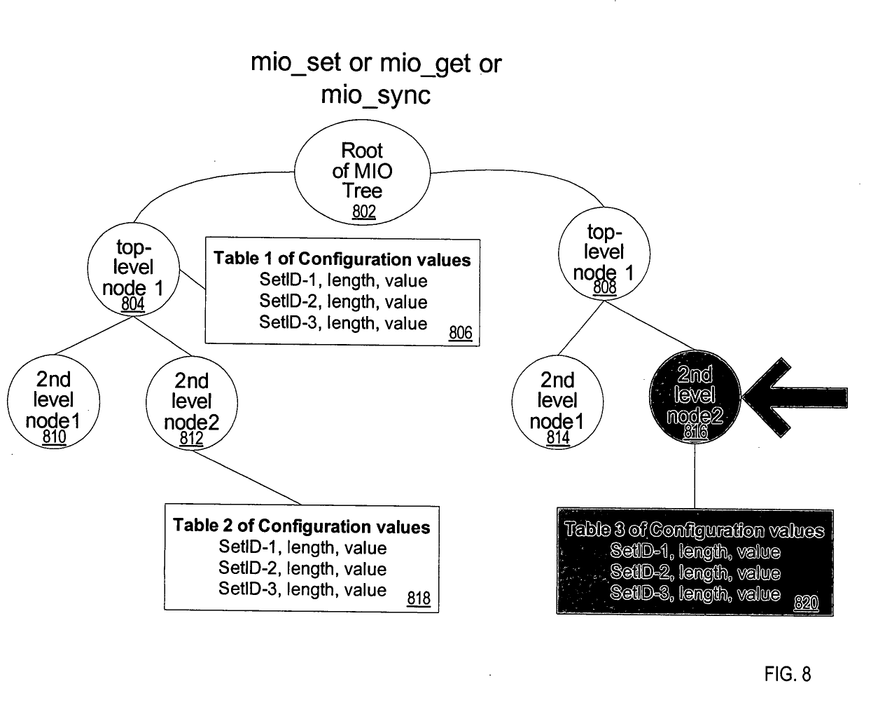

Other mio API calls operate on one node. Such single node commands are: mio_set, mio_delete, mio_sync. FIG. 8 illustrates the operation of the mio_set, mio_delete, mio_sync commands on a MIO tree, according to certain embodiments. FIG. 8 shows a root 802 of the MIO tree, top level nodes 804, 808, and second level nodes 810, 812, 814, 816. Table 806 of configuration values is associated with top level node 804, table 818 of configuration values is associated with second level node 812, and table 820 of configuration values is associated with second level node 816. In FIG. 8, the mio_set, or mio_delete, or mio_sync command operate on the second level node 816, as an example.

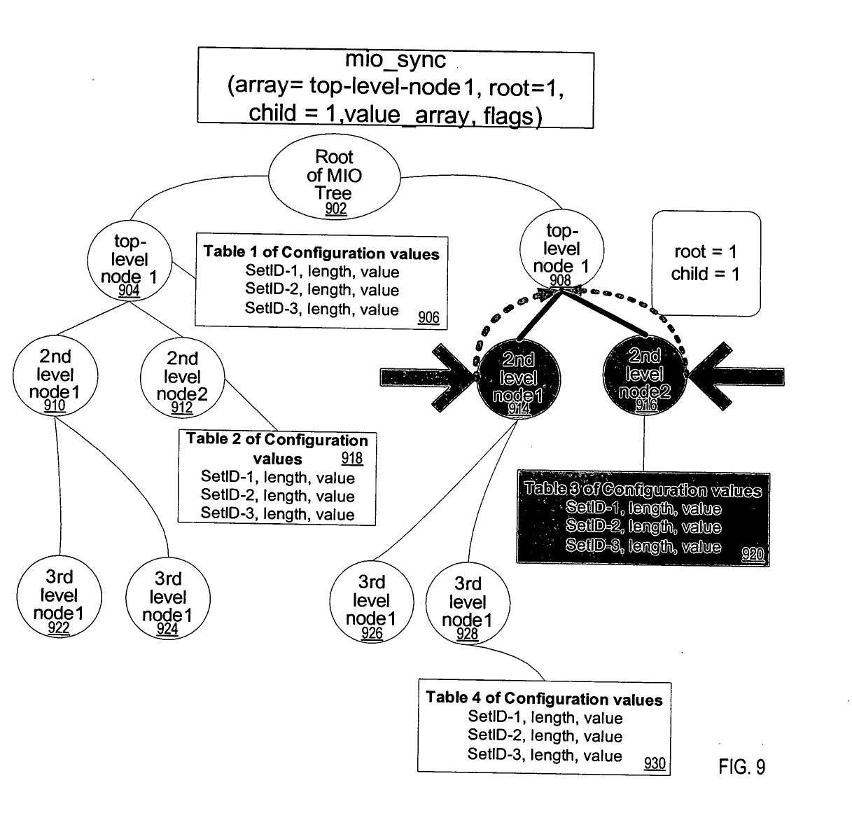

Still other AMI API calls navigate from a point in the tree within a certain range determined by the limit of hops toward the root. API calls that use this type of navigation are: mio_get_next, mio_get_config. The mio_sync_next call can supply a range of hops toward the root of the tree and toward the leaves. FIG. 9 illustrates the mio_sync_next operation on the MIO tree, according to certain embodiments. FIG. 9 shows a root 902 of the MIO tree, top level nodes 904, 908, and second level nodes 910, 912, 914, 916. Third level nodes 922, 924, 926 and 928. Table 906 of configuration values is associated with top level node 904, table 918 of configuration values is associated with second level node 912, table 920 of configuration values is associated with second level node 916, and table 930 of configuration values is associated with third level node 930. In FIG. 9, the mio_sync_next command operates on the second level nodes 914 and 916, as an example.

Canonical Methods For Processing Information Based On Hierarchical Path

Upon finding a node, the user interface may set, modify, delete or query information regarding that node. A configuration node is identified by an array of paths to that node in the hierarchical tree.

To set information into a node, the AMI canonical API has the following calls to set, delete, query or modify the nodes in the configuration tree.

```
mio_error_t *mio_set(mio_tag_array_t *path_array, mio_value_tag_array_t *value_array,
flag_t flags)
        purpose: set values in nodes
        arguments:
            path_array - identifies the MIO tree node that the set is operating on,
            value_array - identifies the values to be set in the table associated with that
            node,
            flags - flag structure giving processing flags
mio_error_t *mio_delete(mio_tag_array_t *path_array)
    purpose: delete a mio node and all its children from the tree
    arguments:
            path array: identifies the MIO tree node that the delete operation is working
            on
mio_error_t *mio_get (mio_tag_array_t *path_array, mio_value_tag_array_t *value_array,
flags)
    Purpose: get values stored at node
    arguments:
            path_array - identifies the MIO tree node that the mio_get is operating on,
            value_array - array of values returned from specific node,
            flags - Flag structure giving global processing flags for get.
mio_error_t * mio_get_next(mio_tag_array_t *path_array, int root, mio_value_tag_array_t
*return_value_array, flags)
    Purpose: get a sequence of parameter values within the “root” distance (in nodes)
    from this node toward the tree root,
    arguments:
            path_array - identifies the MIO tree node that the mio_get_next starts at
            root - flags that control the distance of the walk. The distance (in node hops)
            that the get_next operation will encompass,
            value_array - the returned value array
            flags - Flag structure giving processing flags for set. These flags include (but
            are not limited to) MF_NETWORK_ORDER.
mio_error_t * mio_get_config(mio_tag_array_t *path_array, mio_value_tag_array_t
*value_array, flag_t flags)
    Purpose: Get configuration information stored at the specified node and reports any
    values modified by a user.
    Arguments:
            path_array - identifies the MIO tree node that the mio_get_configuration will
            start with,
            value_array - the return values from the get_config operation,
            flags - Flag structure giving processing flags for set. These flags include (but
            are not limited to) MF_NETWORK_ORDER.
mio_error_t * mio_get_next_config(mio_tag_array_t *path_array, int root,
mio_value_tag_array_t *value_array, flag_t flags)
    Purpose: Get configuration information stored at the next node from the point
    specified toward the root of the tree. It reports only modified values.
    Arguments:
            path_array - identifies the MIO tree node that the mio_get_configuration will
            start with,
            root - limit of MIO tree walk during this operation in terms of nodes toward the
            MIO tree root.
            value_array - the return values from the get_config operation,
            flags - Flag structure giving processing flags for set. These flags include (but
            are not limited to) MF_NETWORK_ORDER.
```

mio_error_t * mio_dget(task *tp, int version, u_int16 handle,
mio_dget_type_t type,
mio_value_tag_array_t *value_array,
mio_dget_reply_fn_t *reply fn, flags_t flags);

Purpose: Get dynamic information from an instance of
communication software pointed to by this MIO node. An example
of dynamic information is statistics specific to a protocol.
Arguments:

tp - task performing
version - query version desired
Type - type of query
Handle ID - cookie to match responses with query
mio_dget_type - type of notification
value_array - query parameters,
reply_fn - callback to invoke when reply data is ready,
flags - used in processing of query

return value: Error codes is returned as pointer to mio_error_t
structure. Null indicates a success.
reply_fn definition:

typedef int (*mio_get_reply_fn_t) (task *tp, u_int16 handle,
mio_path_array_t *ipath,
mio_value_tag_array_t *data, int b, int f)
Purpose: Function to process information returned by dynamic
queries
Arguments:

tp - task requesting
handle - handle used in dget call,
ipath - objects MIO path information
data - data returned from dynamic query
b - non-zero indicates the user may want to buffer calsl
f - non-zero indicates that all information has been
communicated,

return value: False: if data was successfully processed,
True if the data was not successfully processed. (check)

mio_error_t * mio_dget_cancel
(task *tp, mio_dget_queue *q, mio_dget_t *dget)

purpose: Cancel the dynamic query for dynamic
arguments

tp - pointer to task handling this dynamic query,
q - pointer to queue with dget entries
dget - pointer to dget query to be canceled

A different type of run-time information is an event notification. The event notification occurs in the same manner as the statistical information but with a larger potential interval between initial request to watch for the event and the event occurring.

```
mio_error_t * mio_event(task *tp, int version, u_int16 handle, mio_event_type_t type,
mio_tag_array_t *epath, mio_value_tag_array *einfo, mio_event_rcv_t * reply_event_fn,
flag_t *flags);
    Purpose: Set up an event notification
    Arguments:
        tp - task performing
        version - version of event query
        Handle ID - cookie to match responses with query
        type - type of notification
        epath - pointer to node with notification informaiton
        einfo - event related filter parameters,
        reply_event_fn - callback to invoke when event occurs,
        flags - used in processing of query
    Return value: error returns stored mio_error_t * structure
    reply_fn definition:
        typedef int (*mio_get_reply_event_fn) (task *tp,u_int16 handle,
        mio_path_array_t *ipath, mio_value_tag_array_t *data, int b, int f);
        Purpose: Function to process information returned by event occuring
        Arguments:
            tp - task requesting
            handle - handle used in dget call,
            ipath - objects MIO path information
            data - data returned from event notification
            event id - number of event that this data represents (Events start at
            zero
            b - non-zero indicates the user may want to buffer event information
            f - non-zero indicates that all event information has been
            communicated,
        return value: False: if data was successfully processed, True if the data was
        not successfully processed. (check)
mio_error_t *mio_event_cancel (path_array, flags)
    Purpose: Cancel the reception of events from this instance of the communication
    software pointed to by this MIO node.
    Arugments:
        Path_array - pointer to MIO tree node,
        Flags
```

For large configuration changes, the repeated sets, gets and deletes for a large amount of data has been replaced with an API to group configuration requests. The canonical interface provides the ability to queue up a set of configuration changes. At a certain point, the canonical interface enacts queued changes (or commits) the configuration changes.

The AMI canonical interface allows for an intermediate group of configuration changes which a user interface is “working on”. At a particular point, a working set of changes is committed to the “running” routing/communication process. The entire “running” configuration may be saved to permanent storage; alternatively, the changes saved may comprise just the configuration image from a particular node extended to all associated leaves.

Another refinement to the concept of “working” set of changes is the ability of the canonical interface to clear pending changes for a particular node in the tree.

```
mio_error_t *mio_commit( )
    Purpose: commit all configuration changes from
    the root of the MIO tree. Harmonize
    the routing information with other processes.
    Arguments: none - root of tree action
mio_error_t *mio_save_config()
    Purpose - save entire configuration to a binary
    file in the directory specified by build defaults.
mio_error_t *mio_clear_pending(mio_path_array *path_array)
    Purpose: Clear pending configuration changes
    “grouped” for later processing.
    Arguments:
        path_array - pointer to MIO node
```

Checking the synchronization ID of MIO nodes involves checking the calculated revision information versus the user set revision information. If the synchronization id varies, the user-interface and the node's configuration information are out of sync.

```
mio_error_t *mio_sync(mio_tag_array *path_array, mio_value_tag_array *data, flag_t
*flags)
    Purpose: to check synchronization of node. (see section 6.8 for the synchronization
    algorithm)
    Arguments
        Path_array - points to hierarchical node
        Data - returns the synchronization id for the node,
        Flags - Flags that indicate the type of processing per node. The flags provide
        a means to set the synchronization check calculations to:
            Just the node and its immediate children,
            Node and all its descendants
            The flags bits also indicate whether SETID tables have synchronization
            IDs on the whole table or individual entries and the whole table.
            Optionally, the flag bits can determine whether the local process is
            transaction tracking.
Mio_error_t *mio_sync_next(mio_tag_array *path_array, int root, int child,
mio_value_tag_array *data, flag_t *flags);
    Purpose: to check synchronization of nodes within a range of the tree
    Arguments
        Path_array - points to hierarchical node
        Root - gives range that calculation can go toward the root of the tree in terms
        of node hops,
        Child - gives the number of generations of children that can be check in
        measure of node hops. (1 node hop = direct children.)
        mio_value_tag_array *data - array to return data in,
        Flag - a bit mask of processing flags. These flags provide a means to set the
        synchronization check calculations to:
            Just the node and its immediate children,
            Node and all its descendants
            The flags bits also indicate whether SETID tables have synchronization
            IDs on the whole table or individual entries and the whole table.
```

Canonical Interface To The Router/Communication Components

The back-end of the canonical AMI agent has a direct canonical interface to each router/communication component. The router/communication component may be implemented in software, hardware or a combination thereof. A software component is a grouping of software that can be configured and re-configured as a unit.

The canonical interface has 6 well defined functions:

mbe_conf_init( ) - initializes the tree command structure
for the mio agent
mbe_module_init( ) - initializes the mio command tree
structure for all software modules
mbe_conf_data_init(type,ptr) - initializes the node structure
for a single modules
mbe_conf_preset(type,context,ptr) - presets the context for a modules
mbe_conf_config(type,context,ptr) - changes configuration in
the software module
mbe_conf_update( ) - when all configurations are completed,
updates the state between re-configured modules

The mbe_conf_init and the mbe_module_init are global canonical functions to engage the initialization of the the mio_interface. The mbe_conf_config indicates that the configuration of a set of changes to modules is done and the routing software should update the state between modules.

The mbe_conf_data_init function initializes the link of a type of configuration data to a particular routing/communication software module data module (ptr).

The mbe_conf_preset function presets the context for repeated actions. An example of a repreated action is the configuration of a set of static routes.

The mbe_conf_config function incorporates the changes into the routing components or protocols. The order of changes is made in a bottom-up tree order.

MIO messages

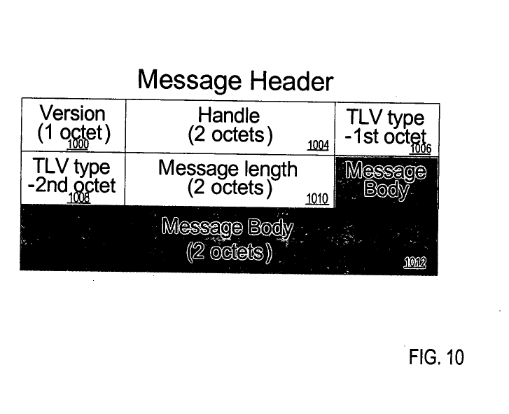

In embodiments of the invention, MIO messages have a common header and unique data messages based on type. FIG. 10 illustrates a sample message header, according to certain embodiments. The message format shown in FIG. 10 shows the version 1000, a handle 1004, a TLV type 1^{st} octet 1006, a TLV type 2^{nd} octet 1008, a message length 1010, and the message body 1012.

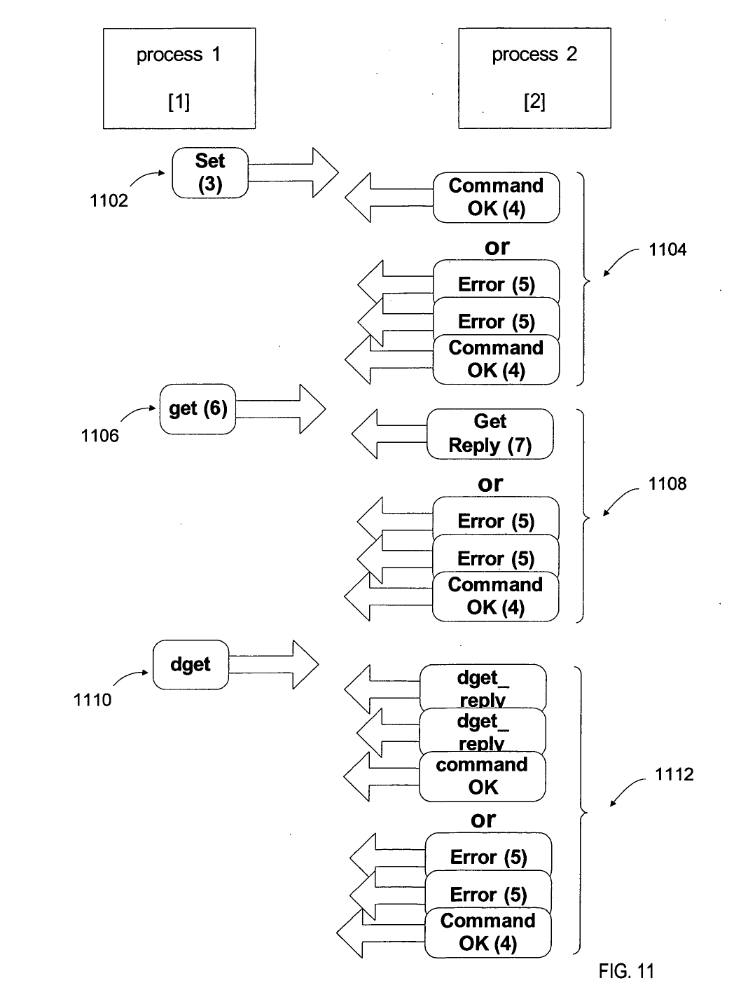

FIG. 11 shows the “set”, “get”, and “dget” message exchanges, according to certain embodiments. FIG. 11 shows the set process 1102, the corresponding set message exchanges 1104, the get process 1106, the corresponding get message exchanges 1108, and the dget process 1110, the corresponding dget message exchanges 1112.

The TLV message types sent from the AMI client to the applicable routing process (non-limiting examples of which include GateD; other examples shall be readily apparent to those skilled in the art) are listed in Table 8.

TABLE 8
MIO message types

| ID | Message type | type |
|---|---|---|
| 1 | Set | From Ami Client API to |
| 2 | Delete | routing process |
| 3 | Commit | |
| 4 | Get Message | |
| 7 | Get Next Message | |
| 8 | Dynamic Get Message | |
| 9 | Clear Pending Message | |
| 10 | Get Config Message | |
| 11 | Get Next Config | |
| | Message | |
| 12 | Save Config Message | |
| 13 | Dynamic Cancel | |
| | Message | |
| 14 | Event Request | |
| 15 | Event Request Cancel | |
| 16 | Action Request | |
| 16 | Action Request Cancel | |
| 17 | Sync | |
| 18 | Sync_next | |
| 100 | Relay Message - relay | |
| | messages from Virtual | |
| | Manager to Virtual | |
| | Communication | |
| | instance | |
| 128 | Error Message | From routing process |
| 129 | Command-OK Message | to AMI client API |
| 130 | Get Reply Message | |
| 131 | Dynamic Get Reply | |
| | Messages | |
| 132 | Event Reply Response | |
| 133 | Action Response | |
| 134 | Sync Response | |

Inbound Messages

Inbound messages or messages that an AMI client can send to a routing process include the Set Message, Delete Message, Commit Message, Get Message, Get Next Message, Dynamic Get Message, Clear Pending Message, Get Config Message, Get Next Config Message, Save Config Message, Dynamic Cancel Message, Event Request Message, Event Request Cancel Message, Action Request Message, Action Request Cancel Message, Sync Request Message, Sync Next Message, and Relay Message.

The Set Message

Type: 1

Length: 4+length of Version and Handle fields+length of message body

Value: PATH and DATA TLVs

The MIO Set message modifies configuration parameters in the specified node. The following TLVs can appear in Set Message:
PATH TLV: Identifies the path from the MIO root node to the node to be created or modified.
DATA TLV: Specifies the configuration parameters to modify at the node specified by the PATH TLV.

If a configuration parameter is of type Optional, as opposed to Key or Required, then the configuration parameter has a default. Such optional parameters can be reset to their default values by specifying the parameter's SetID in a DATA TLV, which has an empty value field. Note that one parameter can be set and another reset using a single MIO Set message. The response to a Set Message is either a Command-OK or an Error message(s) followed by Command-OK.

The Delete Message

Type: 2

Length: 4+length of Version and Handle fields+length of message body

Value: a PATH TLV

The MIO Delete message is used to delete the specified node and all of its descendants from the MIO tree. The value field of a Delete message contains only a PATH TLV, identifying the path from the MIO root node to the node to be deleted.

The entire MIO tree can be deleted by deleting the MIO root node. The root node is identified with its MIO node type, 0:255. The response to a Delete message is either a Command-OK or an Error message(s) followed by Command-OK.

The Commit Message

Type: 3

Length: 4

Value: Empty

The MIO Commit message is used to activate all configuration changes made to the MIO tree since the last Commit operation. A MIO client should send a Commit message after it has sent a batch of Set and Delete messages. The Commit message signals that the client has finished the current batch of configuration changes. The value field of the Commit message is empty. The response to a Commit message is either a Command-OK or or an Error message(s) followed by Command-OK.

The Get Message

Type: 4

Length: 4+length of Version and Handle fields+length of message body

Value: PATH and DATA TLVs

The MIO Get message is a query for the values of the configuration parameters contained in a specified node. The following TLVs appear in this message:

PATH TLV—Identifies the path from the MIO root node to the node to for which parameter values are desired

DATA TLV—Specifies the configuration parameters to query at the node specified by the PATH TLV.

If all parameters in the node identified by the PATH TLV are of interest, then the caller may indicate this either by providing SetIDs for all parameters, or by providing an empty DATA TLV array with no elements. Note that the message sender should take care that only SetIDs, and not SetID values, are specified in DATA TLV since any provided values are cleared/freed by Get operations.

Note that the Get message returns the values of all parameters specified by the PATH TLV, not only those that have been explicitly configured. To obtain information about parameters that have been explicitly configured, please see the Get Config message. The response to a Get message is either a Get Reply message or or an Error message(s) followed by Command-OK.

The Get Next Message

Type: 7

Length: 4+length of Version and Handle fields+length of message body Value: PATH, DATA, and GET NEXT ROOT TLVs

The MIO Get message is a query for the values of the configuration parameters contained in the node following a specified node. In embodiments of the invention, the order of the nodes in the MIO tree is considered to be PREORDER; a parent is visited first, then its children are visited. The following TLVs appear in this message:
PATH TLV—Identifies the path from the MIO root node to the node for which the next node's parameter values are desired.
DATA TLV—Specifies the configuration parameters to query at the next node specified by the PATH TLV.
GET NEXT ROOT TLV—a limit of the walk.

If all parameters in the next node identified by PATH TLV are of interest, then the caller may indicate this either by providing SetIDs for all parameters, or by providing a DATA TLV array with no elements.

The GET NEXT ROOT TLV provides a way to limit MIO tree traversal by allowing one to specify a MIO node above which the traversal should not proceed. The GET NEXT ROOT TLV specifies an index into the PATH TLV. The node referenced at this index is the traversal limit.

Note that the Get Next message returns the values of all parameters specified by the PATH TLV, not only those that have been explicitly configured. To obtain information about parameters that have been explicitly configured (refer to the Get Next Config message). The response to a Get Next message is either a Get Reply message or or an Error message(s) followed by Command-OK.

Dynamic Get Message

Type: 8

Length: 4+length of value field+length of Version and Handle fields

Value: A set of TLVs encoding the parameters for a Dynamic Get query.

The MIO Dynamic Get message is a request for dynamic protocol state. This is the state that, typically, is created as a result of protocol operation and is dependent on the environment in which the router is running. Examples of dynamic protocol state are the number of OSPF neighbors that router currently has and the current state of configured BGP peering sessions. Dynamic state is contrasted with Configuration state, which only changes as a result of modifying the router's configuration.

The response to a Dynamic Get message is either a series of one or more Dynamic Get Reply messages, followed by a Command-OK message, or an Error message(s) followed by Command-OK.

The Clear Pending Message

Type: 9

Length: 4+length of Version and Handle fields+length of message body

Value: a PATH TLV

The MIO Clear message is used to clear any pending (uncommitted) changes to the specified node and all its descendant's nodes in the MIO tree. If a node to be cleared is uncommitted, it and all of its descendants are removed from the tree as well.

The value field of a Clear message contains only a PATH TLV identifying the path from the MIO root node to the node to be cleared. All nodes in the MIO tree can be cleared by clearing the MIO root node. The root node is identified with its MIO node type, 0:255. The response to a clear message is either a Command-OK or or an Error message(s) followed by Command-OK.

The Get Config Message

Type: 10

Length: 4+length of Version and Handle fields+length of message body

Value: PATH and DATA TLVs

The MIO Get message is a query for the values of the configuration parameters contained in a specified node that have been explicitly configured. The following TLVs appear in this message:
PATH TLV—Identifies the path from the MIO root node to the node to for which parameter values are desired
DATA TLV—Specifies the configuration parameters to query at the node specified by the PATH TLV.

If all parameters in the node identified by a PATH TLV are of interest, then the caller may indicate this either by providing SetIDs for all parameters, or by providing an empty DATA TLV array with no elements.

Note that the Get message returns the values of all parameters specified by the PATH TLV, not only those that have been explicitly configured. To obtain information about parameters that have been explicitly configured, please see the Get Config message. The response to a Get Config message is either a Get Reply message or or an Error message(s) followed by Command-OK.

The Get Next Config Message

Type: 11

Length: 4+length of the value field+length of Version and Handle fields+length of message body

Value: a PATH, DATA and GET NEXT ROOT TLVs

The MIO Get Next Config message is a query for the values of explicitly configured parameters contained in the node following a specified node. The order of the nodes in the MIO tree is considered to be PREORDER. A parent is visited first, then its children are visited. The following TLVs appear in this message:
PATH TLV—Identifies the path from the MIO root node to the node to for which the next node's parameter values are desired
DATA TLV—Specifies the configuration parameters to query at the next node specified by the PATH TLV.
GET NEXT ROOT—a limit of the walk

If all parameters in the next node identified by the PATH TLV are of interest, then the caller may indicate this either by providing SetIDs for all parameters, or by providing an empty DATA TLV array with no elements.

The GET NEXT ROOT TLV provides a way to limit MIO tree traversal by allowing one to specify a MIO node above which the traversal should not proceed. The GET NEXT ROOT TLV specifies an index into the PATH TLV. The node referenced at this index is the traversal limit.

Note that the Get Next Config message only queries for parameters that have been explicitly configured. To obtain information about all parameters, please see the Get Config message. The response to a Get Next Config message is either a Get Reply message or or an Error message(s) followed by Command-OK.

The Save Config Message

Type: 12

Length: 4+length of the value field+length of Version and Handle fields

Value: None

The MIO Save message causes the current configuration to be saved in an AMI config file. This file is read when the routing process starts up and provides the initial running configuration. The response to a save message is either a Command-OK or an Error message(s) followed by Command-OK.

The Dynamic Cancel Message

Type: 13

Length: 4

Value: None

The MIO dynamic cancel message causes the cancellation of the existing query that was initiated by a dynamic get messages (AMI_DYNGET_MSG) with the same handle.

The Event Request Message

Type: 14

Length: 4+length of value field+length of Version and Handle fields

Value: A set of TLVs encoding the parameters for an Event request

The MIO Event Request message is a request for dynamic tracking of a management event or management events. A management event is typically, created as a result of protocol operation and is dependent on the environment in which the router is running. Examples of events are the establishment of an OSPF neighbor adjacency on the communication device or the dropping of signal on an interface. The MIO Event Request Cancel message causes the cancellation of the existing event tracking that was initiated by a AMI_EVENT_REQ_MSG with the same handle. The Event Request will be responded to with either a sequence of Event Reply Messages and a Command-OK message or an Error message(s) followed by COMMAND-OK message.

The Event Request Cancel Message

Type: 15

Length: 4

Value: None

The MIO dynamic cancel message causes the cancellation of the existing query that was initiated by a Event request with the same handle.

The Action Request Message

Type: 16

Length: 4+length of value field+length of Version and Handle fields

Value: A set of TLVs encoding the parameters for an Action request

The MIO Action Request message is a request for a management action or actions. A management action is requested to impact communication device operation or protocol operation and is dependent on the environment in which the router is running. Examples of actions are the dropping a OSPF neighbor adjacency or the dropping the signal on an interface.

The MIO Action Request Cancel message causes the cancellation of the existing actions that were initiated by a AMI_EVENT_REQ_MSG with the same handle. The Action Request will be responded to with either a sequence of Action Reply Messages and a Command-OK message or Error message(s) followed by COMMAND-OK message.

The Action Request Cancel Message

Type: 17

Length: 4

Value: None

The MIO action request cancel message causes the cancellation of the existing action that was initiated by a Event request with the same handle.

The Sync Request Message

Type: 18

Length: 4+length of Version and Handle fields+length of message body

Value: PATH and DATA TLVs

The MIO Sync Request message causes the checking of “synchronization ids” at the node. The response to a mio sync request is a MIO Sync response message with the synchronization ID information (generated and non-generated). Per the processing flag, the synchronization can be on the node or the node and the SETID table entries. Synchronization may be done only per node. The response to a sync request message is either: 1) a sync response message or 2) an error message.

The Sync Next Message

Type: 19

Length: 4+length of Version and Handle fields+length of message body

Value: PATH and DATA TLVs

The MIO Sync Next message causes the checking of “synchronization ids” at the node and node range. The response to a mio Sync Request is a MIO Sync Response message with the synchronization ID information (generated and non-generated). Per the processing flag, the synchronization can be on the node or the node and the SETID table entries. Synchronization may be done only per node. The response to a Sync Request message is either: 1) a series of sync response messages followed by a Command-OK message or 2) an Error message(s) followed by COMMAND-OK message.

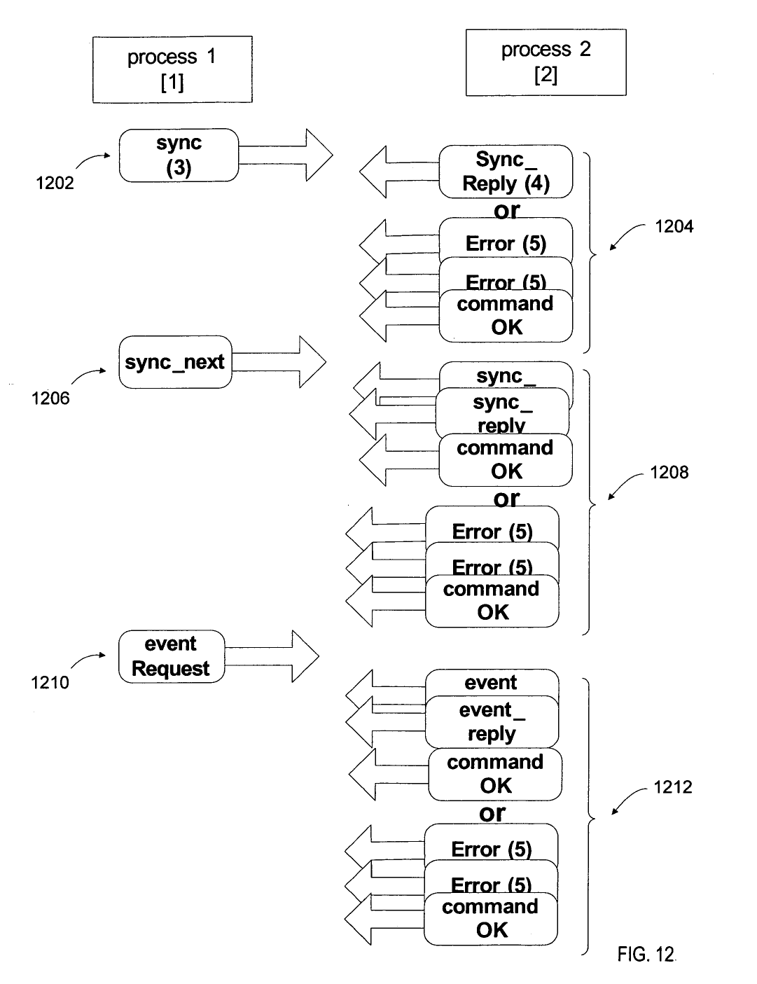

FIG. 12 shows the Sync message, Sync_Next message and Event Message sequences, according to certain embodiments. FIG. 12 shows the Sync process 1202, the corresponding Sync message exchanges 1204, the Sync_Next process 1206, the corresponding Sync_Next message exchanges 1208, and the Event process 1210, the corresponding Event message exchanges 1212.

The Relay Message

Type: 100

Length: 4+length of value field+length of Version and Handle fields

Value: ENGINE, INSTANCE, and MIO message type TLVs

The MIO Relay message is used to indicate that the encapsulated MIO message is to be relayed to another instance of the routing process. This capability is currently used to relay MIO messages to virtual Routers. The Relay message can contain the following TLVs:
ENGINE—Specifies the name of the Virtual Router Engine to which this command is to be relayed. The value of this TLV is the character string engine name of the destination virtual router.
INSTANCE—Specifies the name of the Virtual Router Instance to which this command is to be relayed. MIO-MESSAGE-TYPE—The TLV that contains the actual MIO message to be passed to the specified destination. This is either a MIO Set, Delete, or Commit message.
   Outbound Messages

This section describes messages that a routing process can send to an AMI client.

The Error Message

Type: 128

Length: 4+length of value field

Value: ERROR-CODE, ARRAY-INDEX, and ERROR-MSG TLVs

AMI generates a MIO Error message when it detects an error in an inbound message. The value field of the Error message contains the following TLVs:
ERROR-CODE—Contains the value the error code. This TLV is always present in the value field of an Error message.
ARRAY-INDEX—If present, this contains the element of the MIO PATH TLV or DATA TLV that was found to be a problem.
ERROR-MSG—Contains a textual explanation of the error.
   The Command-OK Message

Type: 129

Length: 4

Value: Empty

AMI generates a Command-OK message in response to an inbound message that successfully processed. The value field of this message is always empty.

The Get Reply Message

Type: 130

Length: 4+length of the value field+length of Version and Handle fields+length of message body

Value: PATH and DATA TLVs

The MIO Get Reply message is the response to a successful Get, Get Config, Get Next or Get Next Config message. It returns the values of the configuration parameters in a specified node. The following TLVs appear in this message:
PATH TLV—Identifies the path from the MIO root node to the node to for which parameter values are being returned
DATA TLV—Specifies the configuration parameters that were queried at the node specified by the PATH TLV.

If a Get Reply message is a response to a Get message, then the PATH TLV is the same as was sent in the Get message. The DATA TLV looks like the TLV that was sent in the Get message with the exception that requested values have been filled in.

If the Get Reply message is a response to a Get Next message, then the PATH TLV is the same as was sent in the Get Next message. Rather, it identifies the node for which parameter values are being returned. The DATA TLV looks like the TLV that was sent in the Get Next message with the exception that requested values have been filled in.

If the Get Reply message is a response to a Get Config message, then the PATH TLV is the same as went sent in the Get message. The DATA TLV looks like the TLV that was sent in the Get Config message with the exception that requested values have been filled in. If a requested parameter has not been explicitly configured, then its value is empty.

If the Get Reply message is a response to a Get Next Config message, then the PATH TLV is the same as was sent in the Get Next message. Rather, it identifies the node for which parameter values are being returned. The DATA TLV looks like the TLV that was sent in the Get Next message with the exception that requested values have been filled in. If a requested parameter has not been explicitly configured, then its value is empty.

Dynamic Get Reply Message

Type: 131

Length: 4+length of value field+length of Version and Handle fields

Value: PATH and DATA TLVs

The MIO Dynamic Get Reply message is the response to a successful Dynamic Get. It returns the values of the configuration parameters in a specified node. The following TLVs appear in this message:
PATH TLV—Identifies the path from the MIO root node to the node to for which parameter values are being returned
DATA TLV—Specifies the configuration parameters that were queried at the node specified by the PATH TLV.

If a Dynamic Get Reply message is a response to a Dynamic Get message, then the PATH TLV is the same as was sent in the Get message. The DATA TLV looks like the TLV that was sent in the Get message with the exception that requested values have been filled in.

Event Reply Message

Type: 132

Length: 4+length of value field+length of Version and Handle fields

Value: PATH and DATA TLVs

The MIO Dynamic Get Reply message is the response to a successful Dynamic Get. It returns the values of the configuration parameters in a specified node. The following TLVs appear in this message:
PATH TLV—Identifies the path from the MIO root node to the node to for which parameter values are being returned
DATA TLV—Specifies the configuration parameters that were queried at the node specified by the PATH TLV.

If a Dynamic Get Reply message is a response to a Dynamic Get message, then the PATH TLV is the same as was sent in the Get message. The DATA TLV looks like the TLV that was sent in the Get message with the exception that requested values have been filled in.

Action Reply Message

Type: 133

Length: 4+length of value field+length of Version and Handle fields

Value: PATH and DATA TLVs

The MIO Action Reply message is the response to a successful Action Request. It returns the values of the result of the action request in a specified node. The following TLVs appear in this message:
PATH TLV—Identifies the path from the MIO root node to the node to for which parameter values are being returned
DATA TLV—Specifies the configuration parameters that were queried at the node specified by the PATH TLV.

If a Action Reply message is a response to a Action Request message, then the PATH TLV is the same as was sent in the Action Request message. The DATA TLV looks like the TLV that was sent in the Action request with the exception that requested values have been filled in.

SYNC Reply Message

Type: 133

Length: 4+length of value field+length of Version and Handle fields

Value: PATH and DATA TLVs

The MIO Sync Reply message is the response to a successful Sync Request. It returns the values of the result of the synchronization check request in a specified node. The following TLVs appear in this message:
PATH TLV—Identifies the path from the MIO root node to the node to for which parameter values are being returned
DATA TLV—Specifies the synchronization id values were queried at the node specified by the PATH TLV.

If a Sync Reply message is a response to a Sync Request message, then the PATH TLV is the same as was sent in the Action Request message. The DATA TLV looks like the TLV that was sent in the Sync request with the exception that requested values have been filled in.

Other TLVs

This section describes TLVs that can appear in the value field of an inbound or outbound AMI message.

Type: 1

Length: 4+length of value field

Value: TLVs encoding a MIO node path

The PATH TLV encodes a path to a MIO node. The value field in turn contains zero or more TLVs, where each TLV encodes a MIO node type, a MIO node key, and the length of the node key. The length of the node key includes the length of the type and length fields. The length field of the PATH TLV contains the length of the PATH TLV's type, length, and value fields.

GET NEXT ROOT TLV

Type: 2

Length: 5

Value: A 1-byte integer

The GET NEXT ROOT TLV encodes the index of an element in a PATH TLV. It is used in the Get Next and Get Next Config messages.

DATA TLV

Type: 2

Length: 4+length of value field

Value: A set of TLVs identifying parameters and parameter values

The DATA TLV encodes the configuration parameter names and values stored at a given MIO node. The DATA TLV's value field in turn contains 0 or more TLVs, where each TLV encodes a SetID, the value of the configuration parameter corresponding to the SetID, and the length of the value of the configuration parameter. This length includes the length of the type and length fields. The length field of the DATA TLV contains the length of the DATA TLV's type, length and value fields.

Lock TLV

Type: 250

Length: 4+length of value field

Value: A set of TLVs identifying parameters and parameter values

The Lock TLV encodes the locking information that will be stored at a given MIO node. The Lock TLV's value field in turn contains 0 or more TLVs, where each TLV encodes a LockID, and the values of the Locking parameters corresponding to the LockID, and the length of the value of the parameter. This length includes the length of the type and length fields. The length field of the Lock TLV contains the length of the Lock TLV's type, length and value fields.

Relay Engine TLV

Type: 256

Length: 4+length of the value field

Value: A string naming a Virtual Router Engine

The Relay-Engine TLV appears in the value field of the MIO Relay message. Its value field contains the name of the Virtual Router Engine to which the message is to be relayed. The name of the engine is encoded as a string (not null-terminated). The length field of this TLV includes the length of the type and length fields, as well as the length of the string.

Synchronization

A method of synchronization of configuration or critical path network monitoring is supported in the AMI canonical remote network management interface.

Synchronization information provides an efficient revision control by creating an “id set” that indicates the revision of a node. This synchronization id has two components: 1) revision id set by remote interface 2) revision id calculated from the descendants of the node. Each revision id has two fields, a shorter revision number and a rotation field.

The node synchronization id tracks the change to a particular node structure. For example, if a process starts up and instantiates the MIO tree for the first all revision IDs within the synchronization ID are set to zero. After the first preset of information to the node or the revision id set by the remote interface should be set to 1. The 2nd change should have a sync_id with a revision number of 2. As each change occurs to the node, a revision number should occur. A change to a node includes changes to children linked to node (additions or deletions) or changes to SETID tables associated with a node.

If node also inherits revisions from any descendants the node has. A descendant of the node is any children or any children of the children recursively. Anytime a node or any of its descendants change, the node is being revised. FIG. 18 shows this method for top-level node 2. Top level node 2, has descendants of node. Node 6 (at level 2) has descendants denoted as 3rd level node-10 and node-11. 3rd-level node 10 has been revised once. 2nd-level node-7 has been revised one. The 1st level node node-2 has been revised.

The checking of synchronization IDs involve calculating the revision IDs based on the children revision IDs. The revision ID greater than or equal to the sum of the revision ids for the children. In the example of node 2 in FIG. 8, the calculated IDs for node 2 would be the same as the set revision id. Node 1 has a revision id that is greater than the sum of it's children due to the revision of the table.

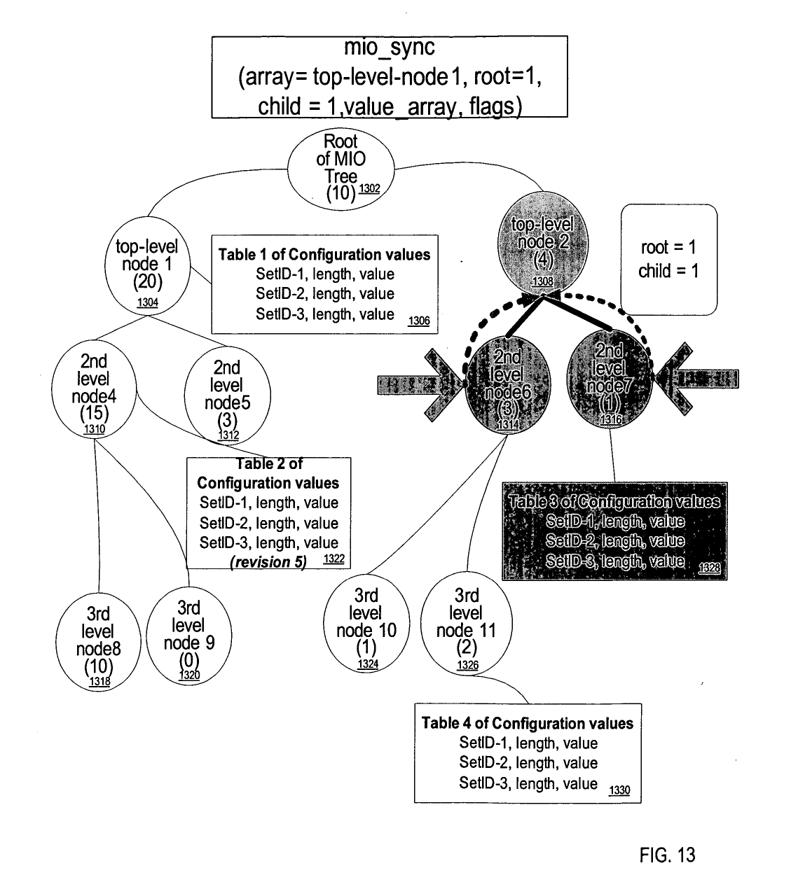

This canonical method optionally allows for the tables and components of the tables to utilize the same synchronization ids. FIG. 13 shows the synchronization and locking processes, according to certain embodiments. FIG. 13 shows a root 1302 of the MIO tree, top level nodes 1304, 1308, and second level nodes 1310, 1312, 1314, 1316. Third level nodes 1318, 1320, 1324 and 1326. Table 1306 of configuration values is associated with top level node 1304, table 1322 of configuration values is associated with second level node 1310, table 1328 of configuration values is associated with second level node 1316, and table 1330 of configuration values is associated with third level node 1326. In FIG. 13, the mio_sync command operates on top level node 1308 and descendants, as an example.

User Interface API and Synchronization Processing

The mio_sync( ) and mio_sync_next( ) APIs provide a means to restrict the method calculation of the generated portion of the synchronization id to: 1) the node and its immediate children or 2) Node and all its descendants or 3) some portion of the tree around the node. The flags bits also indicate whether SETID tables have:

no synchronization IDs,

synchronization ids on the whole table,

synchronization id on individual entries,

synchronization ids on groups of entries by type or range.

These flags govern the synchronization IDs that are returned. In the mio_sync_next, the “root” and the “child” parameter also provide a parameter to the generation of the calculated portion of the synchronization id.

Locking

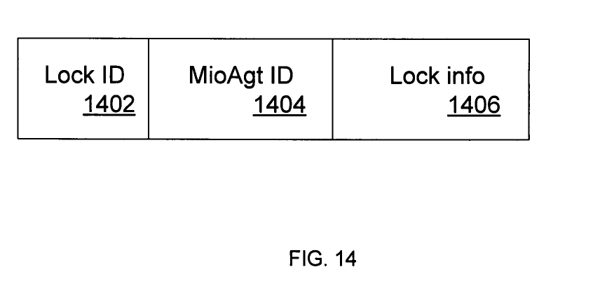

The canonical interface supports locking of the information stored at each node. This locking can occur at any node in the hierarchy. Locking a node locks the node and its descendants (the node's children and recursively their children). FIG. 14 is a block diagram that illustrates the components of a node locking mechanism, according to certain embodiments. In FIG. 14, the node locking mechanism has three parts:

Lock-ID (1402),

identity of the user agent locking the node (1404), and

Locking information (1406).

The locking information contains a flag of lock bits indicating the type of locks on the node. The type of locks include locks for:

all operations

any specific operation defined in the AMI API, or

groups of operations.

The locking information is passed as a TLV. Locking information can include (but is not limited to): time period to lock for, lock until a specific synchronization id, lock during a synchronization range, or lock indefinitely (that is until lock is removed). The use of a Lock-ID allows sharing of a particular set of locking information across multiple nodes.

In the foregoing specification, embodiments of the invention have been described with reference to numerous specific details that may vary from implementation to implementation. The specification and drawings are, accordingly, to be regarded in an illustrative rather than a restrictive sense.

We claim:

1. A computer network system for managing a plurality of communications processes operative on a plurality of devices coupled via a network, the computer network system comprising:
one or more tree-based data structures, each of the one or more tree-based data structures including a plurality of nodes arranged in a pre-defined hierarchy for storing a state of one or more communications processes from the plurality of communications processes, wherein the one or more communications processes implements one of a router, a network switch, a firewall, a network encryption process, a mobile communications device;
an application programming interface including a plurality of operations for querying and updating the plurality of nodes in the one or more tree-based data structures;
for reach of the one or more tree-based data structures, one or more network management agents for querying and updating the state of the one or more communications processes based on a state of the one or more data structures, wherein the one or more network management agents are operative to pre-empt low priority queries to the one or more communications processes in response to high-priority update requests for the one or more configuration processes immediately upon receipt of the high priority update requests from the application programming interface;
one or more user interfaces for viewing a content of each of the one or more data structures and performing the plurality of operations, the one or more user interfaces in communication with the one or more data structures via the application programming interface.

2. The computer network system of claim 1, wherein the plurality of operations includes an operation for locking one or more nodes in the one or more tree-based data structures, the locking operations operative to prevent updates to the one or more nodes.

3. The computer network system of claim 2, wherein the plurality of operations includes an operation for locking one or more nodes in the one or more tree-based data structures, the locking operations operative to prevent querying of the one or more nodes.

4. The computer network system of claim 1, wherein the plurality of nodes in the one or more tree-based data structures includes a state of one of more communications protocols by which the one or more communications processes communicates via the network.

5. The computer network system of claim 4, wherein the one or more communications processes implements a router.

6. The computer network system of claim 5, wherein the one or more communications protocols includes Border Gateway Protocol, and one or more of the plurality of nodes stores a current state of the Border Gateway Protocol in the one or more communication processes.

7. The computer network system of claim 5, wherein the one or more communications protocols includes Open Shortest Path First protocol, and one or more of the plurality of nodes stores a current state of the Open Shortest Path First protocol in the one or more communication processes.

8. The computer network system of claim 5, wherein the one or more communications protocols includes Intermediate System-Intermediate System protocol, and one or more of the plurality of nodes stores a current state of the Intermediate System-Intermediate System protocol in the one or more communication processes.

9. The computer network system of claim 5, wherein the one or more communications protocols includes Intermediate System-Intermediate System protocol, and one or more of the plurality of nodes stores a current state of the Intermediate System-Intermediate System protocol in the one or more communication processes.

10. The computer network system of claim 5, wherein the one or more communications protocols includes one or more label-switch protocol, and one or more of the plurality of nodes stores a current state of the label-switched protocols in the one or more communication processes.

11. The computer network system of claim 5, wherein the one or more communications protocols includes one or more label-switch protocols, and one or more of the plurality of nodes stores a current state of the label-switched protocols in the one or more communication processes.

12. The computer network system of claim 11, wherein the one or more label-switch protocols includes an RSVP protocol, and one or more of the plurality of nodes stores a current state of the RSVP protocol in the one or more communication processes.

13. The computer network system of claim 11, wherein the one or more label-switch protocols includes an LDP protocol, and one or more of the plurality of nodes stores a current state of the LDP protocol in the one or more communication processes.

14. The computer network system of claim 1, wherein the plurality of operations includes an operation for adding a node to the one or more tree-based data structures.

15. The computer network system of claim 1, wherein the plurality of operations includes an operation for removing a node to the one or more tree-based data structures.

16. The computer network system of claim 1, wherein the plurality of operations includes an operation for clearing contents of a node to the one or more tree-based data structures.

17. The computer network system of claim 1, wherein the plurality of operations includes an operation for clearing operations currently pending on the one or more tree-based data structures.

18. The computer network system of claim 1, wherein the plurality of operations includes an operation for real-time notification of pre-defined events occurring on the one or more communications processes.

19. The computer network system of claim 1, wherein the plurality of operations includes an operation for committing operations currently pending on the one or more tree-based data structures.

20. The computer network system of claim 1, wherein the plurality of operations includes an operation for rolling back the state of the one or more tree-based data structures to an earlier state.

21. The computer network system of claim 1, wherein the each of the one or more tree-based data structures are resident on a network device which also runs the one or more communications processes.

22. The computer network system of claim 1, wherein the one or more user interfaces includes a graphical user interface.

23. The computer network system of claim 1, wherein at least one of the one or more user interfaces includes a markup language.

24. The computer network system of claim 23, wherein the markup language is XML.

25. The computer network system of claim 1, wherein the one or more user interfaces communicates with the application programming interface via the network.

26. The computer network system of claim 1, wherein the network is a local area network.

27. The computer network system of claim 1, wherein the network is at least partially a wide area network.

28. The computer network system of claim 1, wherein the hierarchy includes three or more levels.
